(19) United States
(12) Patent Application Publication
(10) Pub. No.: US 2004/0005900 A1
(43) Pub. Date: Jan. 8, 2004

(54) Mobile terminal interactivity with multimedia programming

(76) Inventor: Martin Zilliacus, Kauniainen (FI)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/188,859

(22) Filed: Jul. 5, 2002

(51) Int. Cl. H04Q 7/20

(52) U.S. Cl. 455/466

(57) ABSTRACT

A method allows a user of a mobile terminal to participate in an interactive service relating to multimedia programming. A software application is stored in the mobile terminal. The software application is launched so that it is prepared to receive information concerning the interactive service from a server. Upon receipt of this information, the software application utilizes a stored user interface to prompt the user of the mobile terminal. The software application utilizes previous received information concerning the user so that when the information is received, the user interface prompting the user is provided automatically and without the need for user approval.

### BACKGROUND

1. Field of the Invention

The present invention relates generally to the field of communications. In particular, the invention relates to mobile terminal interactivity with multimedia programming.

2. Discussion of the Related Art

Interactive multimedia programming have previously been limited to telephone calls to or from a television broadcasting studio. For example, viewers could call a particular phone number displayed on the television show to buy products featured or advertised on the show, verbally provide a vote or opinion to a person answering the phone call or to listen to a pre-recorded interactive voice response (IVR) message and press a number corresponding to the desired vote. In an automated voting method, viewers could vote by calling the appropriate one of a plurality of predefined numbers displayed on the television screen for their intended vote—i.e. “Vote now!! Call 1-888-555-1111 to vote YES or call 1-888-555-2222 to vote NO”. Either way, the television show usually counted the votes and announced or published the results of the vote.

A more modern method of voting uses text messages transmitted by facsimile or by a Short Message Service (SMS) through a mobile phone. A problem with text message voting where the viewer types in a text message and sends it to a predefined number is that a lot of votes may be discarded due to spelling mistakes.

Other modern interactive methods direct the viewers to a certain Internet website rather than a phone number. (“Vote Now!! Simply Log on at www.televisionshow.com”). The website may dispense with the need for text messages by implementing a shopping or voting application (developed, for example, using the Java programming language from Sun Microsystems of Santa Clara, Calif.) that works in conjunction with a browser on the viewer's computer or set top box and merely requires the viewer to check boxes using a cursor pointing device, such as a computer mouse.

However, such interactive websites do not adequately and completely solve the problems of shopping, advertising, voting or other types of viewer interactivity with video programming. Although they allow different types of viewer interactivity to take place without entering text, they have the disadvantage of being cumbersome at least because they require the person to have a computer or a set top box, to have Internet access on their computer or set top box, and to be near or otherwise able to use their computer or set top box when it is time to vote, and, if necessary, to be willing to take the preliminary steps necessary to vote or perform any other type of viewer interactivity, i.e., open a browser software application and log onto the website. These interactive websites are also slow and the lack of immediacy is a large disadvantage in circumstances where a viewer's emotional reaction to the multimedia programming causes them to want to immediately buy a product, respond to advertising, vote, etc.

There are now numerous networks and inter-network protocols that carry various forms and combinations of multimedia content such as voice, video, web content, graphics and text. As used in this application, the term “multimedia” refers to any content having a visual element. The mobile terminals of wireless communication networks, particularly phones of cellular networks, are now capable of transporting data, including multimedia data. Many types of mobile terminals are being used, such as cellular phones, cordless telephones, personal digital assistants (PDAs), palm-held computers and laptop computers. The strong push in current wireless technology development is to use mobile terminals for varied applications and to allow users of such devices to seamlessly integrate events and needs in their lives while maintaining adequate communications power to receive and transmit all of the data and information which has an impact on them.

Furthermore, most people have particular preferences for interactivity with video programming and other types of multimedia content. There does not exist today a system or method for setting such preferences with a mobile terminal. Such systems and methods would greatly simplify and enhance a user's viewing habits and make it extremely easy for such habits to be influenced, categorized and exploited by providers of multimedia programming.

Unfortunately, the manner and duration of the procedure necessary for obtaining multimedia content may vary widely and unpredictably in wireless communication networks supporting advanced mobile terminals, and allowing a user to subscribe to and access a variety of different multimedia communication services (i.e., so-called third generation (3G) and fourth generation (4G) networks). An advanced mobile terminal supported by such a network and using the latest innovations in computers, software, displays and other technologies may access and receive many different multimedia formats. These multimedia services may be provided by different information sources in other networks and may be based on and built upon a variety of data transfer techniques. This introduces more delay and uncertainty into mobile terminal interactivity with multimedia programming.

For at least these reasons, present methods of interactivity with multimedia programming have disadvantages. Accordingly, there is a need for effective solutions that allow for easy and substantially immediate mobile terminal interactivity with multimedia programming.

### BRIEF SUMMARY OF THE PREFERRED EMBODIMENTS

To overcome limitations in the prior art described above, and to overcome other limitations that will be apparent upon reading and understanding the present specification, it is therefore an object of the following described preferred and exemplary embodiments to overcome the above mentioned disadvantages. In particular, an object of the preferred and exemplary embodiments is to provide a solution which facilitates substantially immediate mobile terminal interactivity with multimedia programming.

In the preferred and exemplary embodiments, a Java enabled mobile terminal in a wireless communication network facilitates substantially immediate user interactivity with video programming. A software application provides functionality on the display of the mobile terminal to prompt the user and allow them to easily vote or to engage in another other type of interactivity without the need for entering text or excessive inputs.

A particular aspect of the preferred and exemplary embodiments involves a voting application on the mobile terminal according to which information relating to the vote is substantially immediately downloaded and presented to the user on the mobile terminal without being initiated by the user. Preferably, the user can respond by making one simple click to select from available choices based on the information presented.

This and other features of the preferred and exemplary embodiments of the invention will become apparent and better understood from the following detailed description when considered in conjunction with the accompanying drawings. It is to be understood, however, that the detailed description and drawings are designed solely for the purposes of illustration and not as a definition of the limits of the invention, for which reference should be made to the appended claims.

### BRIEF DESCRIPTION OF THE DRAWINGS

In the drawings, wherein like reference numerals identify similar elements throughout the several views:

FIG. 1 is a block diagram of a system providing for mobile terminal interactivity with video programming according to an embodiment of the present invention.

FIG. 2 is a high level flow diagram depicting a typical scenario in which the system of FIG. 1 is deployed to effect interactivity with video programming.

FIG. 3 is an illustration of a voting application and chat application on a mobile terminal according to an embodiment of the present invention.

FIG. 4 illustrates an embodiment of the software architecture for the voting application and chat application shown in FIG. 3.

FIG. 5 is an end-to-end diagram of an exemplary system implementing the software architecture of FIG. 4.

FIG. 6 is a flowchart illustrating a voting application method, with registration, in the mobile terminal according to a preferred embodiment of the invention.

FIG. 7 is a sequence diagram illustrating the information passed between elements in the voting method of FIG. 6.

### DETAILED DESCRIPTION OF THE PREFERRED EMBODIMENTS

In the following description of the various preferred embodiments, reference is made to the accompanying drawings which form a part hereof, and in which is shown by way of illustration various preferred embodiments in which the invention may be practiced. It is to be understood that other embodiments may be utilized and structural and functional modifications may be made without departing from the scope of the present invention.

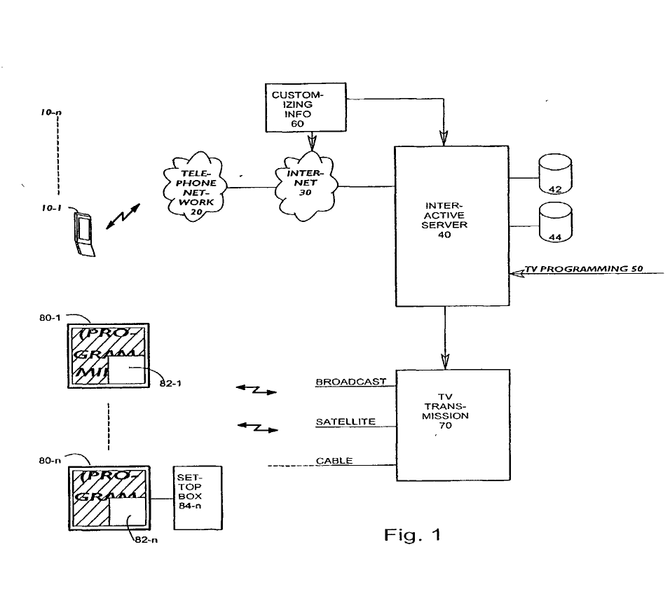

Attention now is directed to FIG. 1, which shows a block diagram of a preferred and exemplary system for mobile terminal interactivity with video programming according to a preferred embodiment of the present invention. It will be appreciated that the present invention is applicable to customizing also other multimedia content such as radio, jukeboxes, and also other media.

There are an unspecified plurality of users, each equipped with a respective mobile terminal 10 and a respective video system 80. The mobile terminal 10 may be any mobile terminal capable of communicating via the Internet. Preferably, the mobile terminal 10 is capable of continuously connecting to the Internet (such as in the General Packet Radio Service (GPRS)) and is Java enabled using, for example, Java 2 Micro Edition (J2ME) available from Sun Microsystems, Inc., of Santa Clara, Calif. However, the embodiments of the invention may be used with new types of mobile terminals devised in the future that utilize technologies other than GPRS and J2ME. The mobile terminal 10 can bi-directionally communicate with the Internet 30, typically, though not necessarily, through a wireless telephone network 20. It should also be understood that the mobile terminal 10 may use an alternative access network and proxy server, especially when roaming.

The video system 80 of a user may be nothing more than a conventional television set receiving television signals in any one or more of a variety of ways, such as broadcast, cable, or satellite, or it may be a system capable of receiving and displaying any one or more of various streaming video formats. In the case of a conventional television set, the television set typically has associated with it a set-top box 84, which, as is known in the art, can interact with an incoming signal for channel selection and the like. Alternatively, the broadcast signal could be transmitted over a digital video broadcasting terrestrial (DVB-T) network, a cable network, satellite, or through a wireless local access network (WLAN). Indeed, the video programming can also be broadcast directly to the mobile terminal(s), thus advantageously removing the need for the viewer to be close to a television set.

In either case, the video system 80 is preferably able to display supplementary text or other material (i.e., text or other material in addition to the normal video programming on a channel) in a small window 82, such that the normal video programming is substantially visible while supplementary material is displayed in the window 82. An example of such a system is a picture-in-picture system known in the art. Alternatively, supplementary text or other material may be displayed superimposed on the video programming, in the same manner as movie subtitles, or in a transparent overlay.

The superimposing of the text or other material on top of the video programming can be generated for example: a) at the broadcasting site, resulting that each viewer will see the same content, which cannot be turned off; b) locally at the television set (in a manner similar to current teletext systems); in which the text or other material (such as an alternative language) although broadcast from a central location is selectable by the viewer; or c) locally at the set-top box, which gives personalization possibilities to the end user. For example, a set-top box (with bluetooth) can adjust the local content superimposed when identifying that a bluetooth enabled mobile phone is in the vicinity.

The user of the mobile terminal 10 communicates for example via the Internet 30 with an interactive server (IS) 40. Associated with the IS 40 are an accounts database 42 for storing user account information and a registration database 44 for storing user registration information. Generally, the account information may include persistent information such as a user's name, sex, age/date of birth, address, credit card numbers, general likes and dislikes, hobbies, and so forth, while the registration information may include more volatile type of information such as that the user is currently viewing a particular program, that she wishes to participate in a current poll or special offer mentioned on a television program, or the like.

The IS 40 receives video programming 50, which it forwards for transmission to for example a conventional TV transmission network 70 for distribution to a plurality of respective video systems 80. Although not shown in FIG. 1, the IS 40 may also provide information over a second broadcast channel to mobile terminals enabling the terminals to attend to available interactive services relating to the video programming in the first channel. The second channel may be in a digital television broadcasting network. The second signal may be sent directly to the mobile terminals or indirectly through a set top box or similar video device such as the Nokia media terminal, which communicates with the mobile terminal through any appropriate connection (e.g., bluetooth).

As will be discussed below, the IS 40 may modify or augment the video programming 50 prior to such forwarding in accordance with the described embodiments of the invention. Alternatively, the IS 40 may not receive the video programming 50 at all, and may instead provide only the information for modifying or augmenting the video programming 50 and such modification or augmentation is performed in the TV transmission network 70 or in some other element associated with the TV transmission network 70.

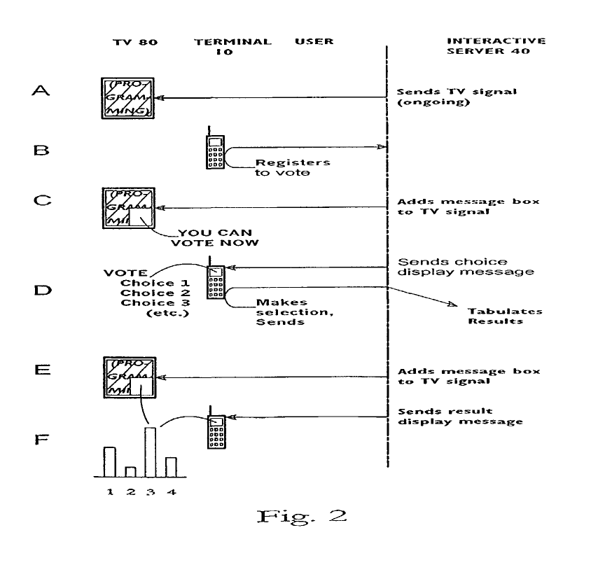

Before describing the preferred implementations according to the embodiments of the invention, a general method of interactive voting within the capabilities of broadcast TV reception is illustrated in FIG. 2. Line A indicates that a user is watching a particular program (called “Program A”). In Program A, it is announced (perhaps by a person hosting the video programming) that viewers will be polled for their views on some topic presented in the Program A. The user may then register to vote in the poll (Line B). Registration generally refers to the action taken by the user to indicate their interest in participating in the vote or other interactive function. (As discussed further below, registration may be accomplished in a particular embodiment by having the user ask for a java applet by sending e.g. a SMS message to a defined number. In return for the request, the user will get the applet for doing the specified interactive function.)

At some later time (allowing time for all viewers who wish to register to do so), the IS 40 adds content to the video programming to cause each user's video system to display in for example a small window (while Program A remains substantially visible) a legend indicating that actual voting has commenced, as indicated in line C of FIG. 2. (All viewers see this via broadcast of Program A, regardless of whether they have registered to vote.) The length of time the legend is left on is a design choice. Only those who have registered to vote (determined by polling the voting registrations in registrations database 42) then receive a voting menu on their mobile terminal 10 from IS 40 via Internet 30, as indicated on line D of FIG. 2. Receipt of the menu could be accomplished in many different ways. For example, it can be done locally by the application or the menu content could be transmitted at activation time. The user then makes a selection and sends IS 40 a message containing the selection.

After a reasonable period of time for voting to take place, (optionally announced by legends added to the video programming, e.g., ‘VOTING ENDS IN n MINUTES) the IS 40 tabulates the results. The IS 40 and/or the application can have safeguards to ensure that a user does not vote more than once. For example, when a user of mobile terminal 10 has registered for a vote, the IS 40 can provide a unique identifier to that user. The user's unique identifier may be combined or attached to the voting midlet when the midlet is supplied to the mobile terminal 10 or the unique identifier may be provided at some other time or in some other manner. The mobile terminal 10 may then be required to combine or attach the unique identifier to the user's vote and to provide the combination of vote and identifier to the IS 40. IS 40 may refuse to recognize a vote unless it is accompanied by a valid unique identifier and, once it has received a vote accompanied by a unique identifier, refuse to acknowledge any other votes accompanied by that unique identifier. The voting results are then sent to the video systems 80 (seen by everyone watching Program A) and to the mobile terminal 10 of only those users who registered to vote, as shown in lines E and F respectively of FIG. 2.

The preferred embodiments of the invention are concerned with improving the interactivity of the mobile terminal 10 in lines B and D of the general method shown in FIG. 2. To accomplish this, a software application is stored in the mobile terminal 10. Having the application resident on the mobile terminal 10 decreases the amount of information which must be transmitted to the mobile terminal 10, increases the speed of the interactive service, and allows the user interface for the voting to be well designed with suitable graphical elements for the mobile terminal 10.

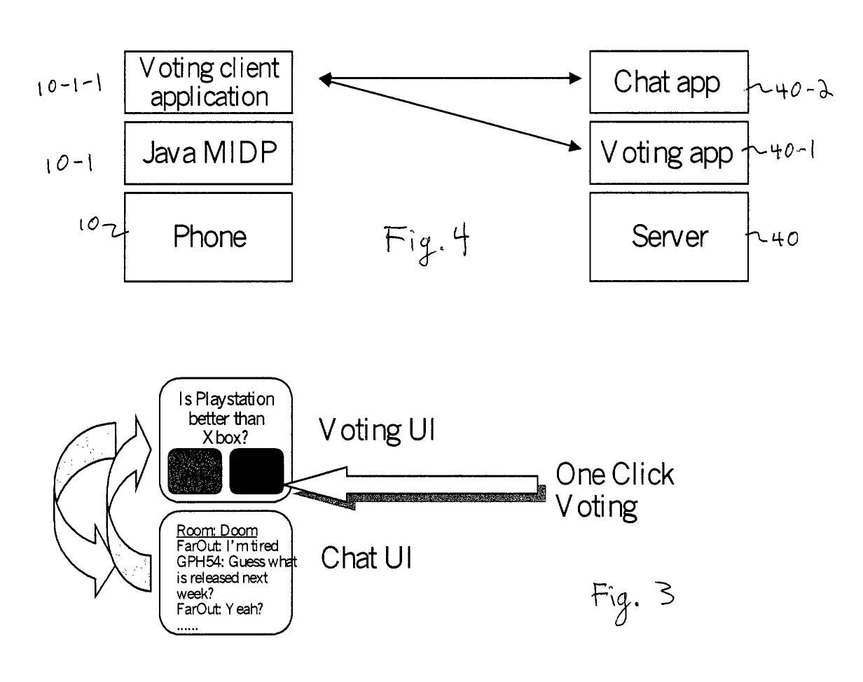

FIG. 4 illustrates the preferred general architecture of the mobile terminal 10. In this preferred implementation, the mobile terminal is a J2ME enabled mobile phone 10 including a configuration, such as the Connected Limited Device Configuration (CLDC), defining the minimum Java Platform functionality for the mobile phone. In particular, the configuration defines the minimum number of Java libraries, VM capabilities and a security specification that governs the behavior of Java applications running on a given device or a family of devices.

The mobile phone 10 also includes Mobile Information Device Profile (MIDP) 10-1, which is a collection of Java APIs that supplement the CLDC configuration to provide capabilities for the specific mobile phone. Java MIDP 10-1 provides display toolkit APIs and input methods, HTTP-based networking using the Generic Connection Framework found in CLDC, and persistent data storage APIs. Voting application 10-2 is a Java midlet that uses the elements of JAVA MIDP 10-1 to provide a quick and easy voter interface on the mobile phone 10 under the direction of a voting application 40-1 on the IS 40.

The preferred and exemplary embodiments also enable chatting interactivity by viewers of the video programming on their mobile terminals 10. For example, users watching a particular video program may enter comments about the program on their mobile terminals 10. These comments are forwarded by the IS 40 for display on terminals 10 of other users registered as watching that program, as determined, for example, from the registrations database 44. Also, a chat application 40-2 on IS 40 can cause the comments to appear in the window 82 of video system 80 of users viewing the program through a suitable set-top box.

Preferably, the user can select between different interactive applications, for example, a voting application and a chat application. FIG. 3 illustrates simple examples of a user interface for the voting application (Voting UI) and the user interface for the chat application (Chat UI) and the ability of a user to switch between the user interfaces. Although not shown in FIG. 3, there may be a menu providing various service options. Also, the user interface is shown in FIG. 3 as being rather simple, the user interface may take a variety of forms and be in any number and combination of multimedia formats (video, audio, graphics, animation, etc.). The content may serve a variety of informational purposes other than or in addition to voting. It may, for example, announce the identity or source of the video programming, either with text, audio, video or graphics.

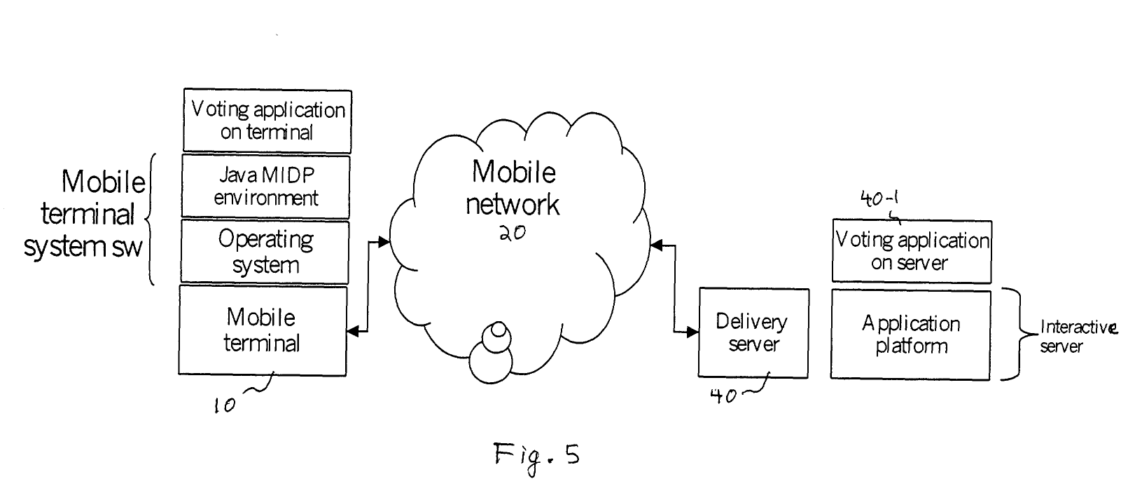

FIG. 5 is an end-to-end diagram similar in some respects to the generic diagram of FIG. 1 but illustrating a system utilizing the JAVA implementation. On the left end of FIG. 5, the system software of mobile terminal 10 includes an operating system and the Java MIDP environment. A voting application is resident on the mobile terminal and utilizes the system software of the mobile terminal. Mobile network 20 provides conventional functions such as connection and authentication of users on the network, preferably using standardized protocols. (Mobile network 20 also provides billing support.) The Interactive server 40 may include an application platform containing the application runtime environment, multiple person registration and login, and voting result check and reporting; and supporting a voting application loaded on the server. The IS 40 may further include point-to-point application delivery, delivery security and completeness' consistency checks and delivery reporting.

There are several general methods in which a user, by registering with the IS 40 through his/her mobile terminal 10, is able to exert some control over what appears on his/her video system 80. The simpler methods involve those of the TV sets that receive the TV programming via broadcast; the TV sets must display everything contained in the received signal on a selected channel, as opposed to those of the TV sets 80 that receive satellite or cable signals and process them in a set-top box 84 which allows selections to be culled from the received signal on a selected channel.

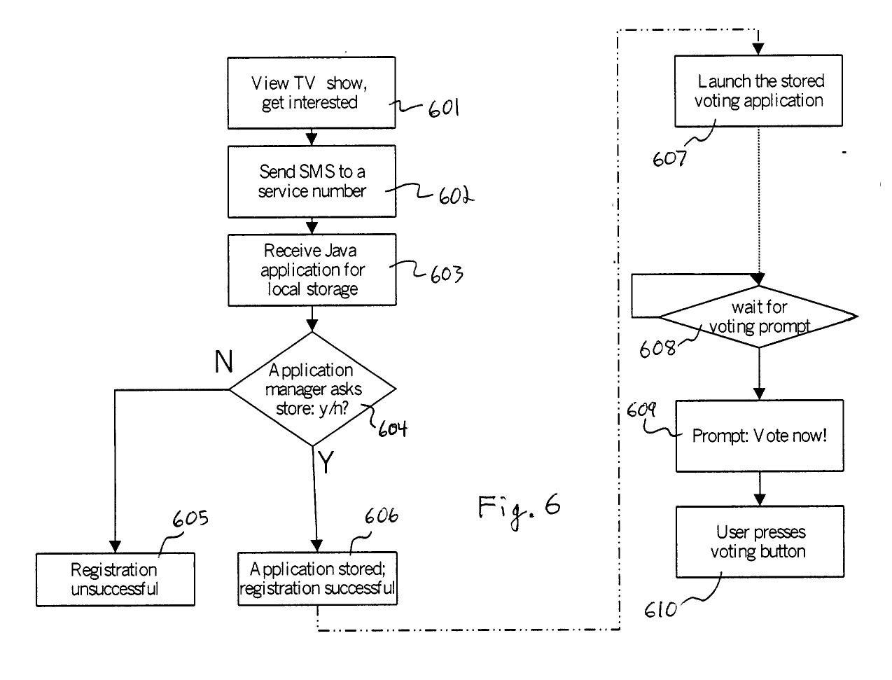

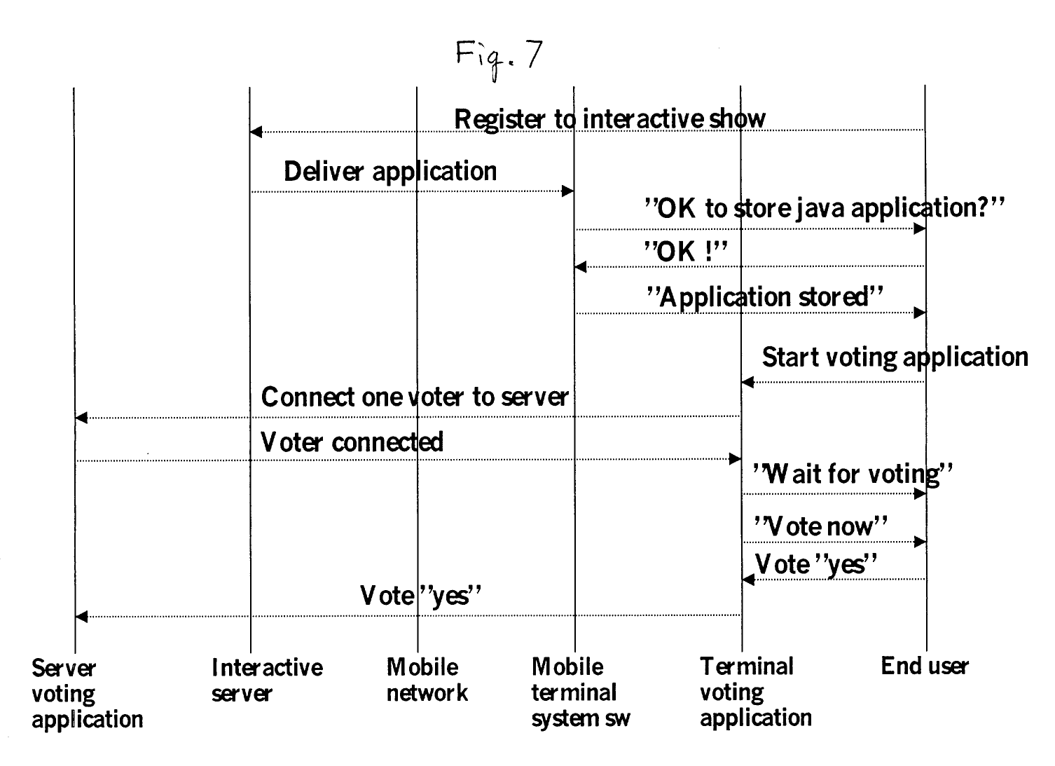

A preferred embodiment of the registration and voting steps is set forth in FIGS. 6 and 7. As shown, a user watching a particular video program, here called “Program A” by way of reference, may become interested (FIG. 6, step 601) and wishes to register for interactive services. The user can use his/her mobile terminal 10 to communicate with the IS 40 indicating interest in receiving interactive services regarding Program A. This can be done, for example, by sending an SMS message to a service number to “register” for Program A (step 602).

Other identification information that may be contained in the registration message transmitted by the mobile terminal 10, such as a wireless phone number or an email address, may be used to identify the user's account in database 42, from which demographic information (e.g., her sex and age) may be extracted. (In an alternative embodiment, such demographic information may be part of the message transmitted by the mobile terminal 10, perhaps from a template stored therein.) The registration (including demographics) may be stored in registration database 44. It is a design choice when to remove registration entries from registration database 44; for example a registration stating that a user is watching a particular program can be removed when that program is over; a registration stating that a user wishes to participate in a poll may be removed when the poll is completed, plus some predetermined time during which participants may review poll results.

A user wishing to view video programming in a different language can register while watching the program, and request subtitles in another language. If such subtitles are not available, the user is so informed. If they are available, the IS 40 may append them to a satellite or cable transmission of the program for extraction by the user's video system 80 and subsequent display to the user. Alternatively, an audio soundtrack in the requested language can be fed to the user's mobile terminal 10. The user may be charged for this service through an account determined by the accounts database 42.

Upon registration, mobile terminal 10 receives a Java application to be stored in the mobile terminal (step 603). The Java application can be pushed through the Internet or automatically downloaded if the mobile terminal has previously registered for other video programming. Preferably, but not necessarily, a marker or flag can be set to indicate that a certain user has registered and received an application. It can be retrieved through WAP, SMS, MMS, etc.

The mobile terminal 10 may have anyone of a variety of different software application managers for managing software resident on the mobile terminal. Preferably, the software manager is terminal and implementation dependent. At step 604, the software application manager asks the user to authorize storing of the Java application on the mobile terminal. If the answer is no, then the Java application will not be stored on mobile terminal 10 and registration will be unsuccessful (step 605). If the answer is yes, then the Java application will be stored and registration is successful (step 606).

Once stored in the mobile terminal 10, the Java application can be launched (step 607) at any time as long as the connection is active, such as in General Packet Radio Service (GPRS). The launch can be user activated, activated by the IS server 40 or activated at the same time the application is retrieved and stored in the terminal. When the application is launched, the user is connected to the IS server 40. However, the user does not have to be present since the connection can be completely stateless and/or sessionless. Once the application is active, it waits until a voting service is activated (step 608). Preferably, the user does not have to respond to a query (“OK to start a vote?”). This can be avoided, for example, by using a J2ME API developed by the Java Community Process which allows a Java midlet to directly send and receive SMS messages. Voting activation is preferably done by the server, but it can also be done by the user, by SMS/WAP push, by a direct GPRS connection (IP or similar), or even by a separately broadcasted video program. Alternatively, the voting application can be activated using a cell broadcast service of GSM or 3G network (the application can wait for this to occur when there is a MIDP application programming interface providing this information) or the radio data system (RDS) of the analog radio broadcast (see, for example, www.rds.org.uk/rds98/rds98.htm).

Once voting is activated, a prompt is automatically provided to the user without the user having to take any action or confirmation to the voting (step 609). It is particularly preferable that the prompt be made substantially immediately after the event in the video programming to which it relates. The prompt includes at least a display shown to the user on the display of the mobile terminal, but may also consist of tactile notification, such as vibration of the mobile terminal, or a distinctive ringing tone. The user can then respond to the prompt by pressing a voting button or taking other action to indicate his/her vote (step 610). It is a particular feature of the preferred embodiments that the software application utilizes information previous obtained (such as in the registration process) and requires only one single action by the user in response to the prompt. The software application preferably sends the voting information without any further actions necessary by the user. If the user's voting information is pushed to the IS server 40 with a hypertext transfer protocol (HTTP), then the IS server 40 does not need to have previously stored information relating to the user and/or the user's session. The software application can send the information in any number of ways, for example, by GPRS or SMS. It may also delay sending the information slightly depending on the capacity of the server and the network.

The IS 40 also receives customizing information 60, which may include advertisements, announcements of polls and candidate lists for polls, product information, special offers, lottery statistics, lottery results, etc. As a design choice, the customizing information 60 may be provided to the IS 40 directly from some source proximate to the IS 40, remotely via the Internet 30 (as from a remote web server) or any combination of the two.

Periodically, a function in the IS 40 reviews registrations 44 to deduce demographic patterns. For example, it may be found that more females aged 17 to 30 are watching Program A than any other single demographic group. The IS 40 might then elect to replace the advertisements contained on the corresponding channel in the video programming 50 with advertisements more appropriate to females aged 17 to 30. These other more appropriate advertisements would have been obtained by the IS 40 as part of customizing information 60. Thus, everyone watching Program A, regardless of whether receiving it via broadcast, cable, or satellite, will see the substituted advertisements in lieu of those provided in the video programming 50 stream.

A scenario that can have different results according to whether a user is receiving video programming via broadcast or through a set-top box from cable or satellite is now addressed. A user is watching a particular program (Program B), and registers as watching Program B. The user may be interested in a product that is advertised during Program B, and may make an entry via his/her mobile terminal 10 requesting further information about the product. One simple response would be to obtain the users email or postal mail address, perhaps from the accounts database 42, and to mail the user more information about the product. Providing additional information immediately via the user's video system 80 is not feasible if the user is receiving via broadcast, because the additional information appended to the broadcast TV signal would be seen by all viewers of Program B. But if the user is receiving via cable or satellite through a set-top box 84, then it may be possible (according to the specifics of the cable or satellite transmission method, as is known in the art) to append the additional information to the video programming in such a manner that only the intended user's set-top box extracts it from the signal and displays it to the user. Or if several users have requested additional information on the same advertised product, they may receive it for viewing simultaneously while users who have not requested it do not see it.

The ability the of set-top box 84 to extract signals for particular users can be used with the present invention for tailoring advertisements to demographic groups of users. While the basic set of advertising on a channel can be set according to the dominant demographic group of viewers as discussed above, user account data 42 and user registration data 44 are interrogated to determine other significant areas of interest among users, and advertisements or special offers targeted accordingly to specific groups are appended to the signal with sufficient destination information that set-top boxes 84 show the alternative advertisements or special offers to targeted users.

While an advertisement, product information, a special offer, or the like is being presented to a user, the user could enter a BUY indication on his/her mobile terminal 10. The IS 40 determines what product the user was viewing at the time (different users could be seeing different products). Thereafter the IS 40 retrieves the user's shipping information and e.g. credit card number from the accounts database 42 and arranges to ship the advertised or offered item to the user.

Customizing information 60 may introduce special offers in conjunction with the video programming as well as in conjunction with advertising. For example, while registered to view a drama program, a user receives from the IS 40 a message on his/her mobile terminal 10 (accompanied by an audible signal such as a beep to draw their attention) that says, e.g., “BUY THE DRESS MELANIE IS WEARING—ONLY $99” (where Melanie is one of the characters in the drama program).

Lotteries are another possible area of interactivity. A user signifies on his/her mobile terminal 10 that he/she wishes to participate in a lottery (perhaps in response to advertisements or prompts for the lottery included in video programming). If participation in more than one lottery is possible, the IS 40 sends a menu back to the user's mobile terminal 10 for selection of one lottery. The user is then prompted to enter his/her selection of lottery numbers.

The user's selection of lottery numbers is forwarded to the IS 40, which registers the user as participating in the registrations database 44, and which may determine the users financial account number from the accounts database 42. Administration of the lottery might be performed in the IS 40, but more typically is performed in some other web server (not shown) accessible through the Internet 30. The IS 40 forwards the users selected lottery numbers to the lottery administration function, and sends a display message back to the user's mobile terminal 10 confirming participation in the lottery and debiting of the user's account.

At a later time when the winning lottery numbers have been selected, the winning numbers might appear appended to video programming, and each user participating the lottery (as determined from registrations database 44) may receive with his/her mobile terminal 10 a message from the IS 40 personalized according to his/her individual results (e.g., “YOU HAVE WON $50,000,000” or “TWO NUMBERS MATCH—NO WINNINGS”, etc).

A user entering the lottery may send a request to see the most commonly selected numbers. (Such a function might be a menu item on the aforementioned display that is provided to prompt the user to enter lottery numbers.) The IS 40, upon receiving such a request, interrogates the lottery administration function and forwards a message for display on the mobile terminal 10 of all users who have requested to view the most selected numbers. Such a display might typically be in the form of a histogram, depicting a line associated with each of several numbers, the relative line length indicating the popularity of the number. If the IS 40 detects that a large number (i.e., above some predetermined threshold) of users request to see the most commonly selected numbers, the IS 40 will append a display thereof to the video programming.

While the invention has been described with reference to example embodiments, the description is illustrative and is not to be construed as limiting the invention. In particular, the various references to mobile terminals and Java refer merely to the terminology used in association with the preferred embodiments and is not meant to imply that the method according to the example embodiments must only be used with certain types of mobile terminals or implementing technologies.

1. A method of providing an interactive service relating to a video program at a mobile terminal, comprising:
launching a software application stored in the mobile terminal, said software application, when launched, being prepared to receive information from a server relating to said video program;
activating said software application upon the receipt of said information from the server relating to said video program, said activation including invocation of a user interface defined by said software application;
prompting the user to provide an input to the interactive service, said prompt utilizing previous information concerning the user so that said prompt is provided automatically upon receipt of said information relating to said video program and without the need for prior action by the user; and
receiving the prompted user input and sending information indicating said prompted user input to said server.

2. A method in accordance with claim 1, wherein said prompt requires said user to take only a single action to provide said prompted user input.

3. A method in accordance with claim 2 wherein:
the mobile terminal is Java enabled.

4. A method in accordance with claim 3 wherein:
said software application is a Java midlet.

5. A method in accordance with claim 4 wherein:
said application is launched by said server.

6. A method in accordance with claim 4 wherein:
said application is launched by the user of the mobile terminal.

7. A method in accordance with claim 4 wherein:
said application is provided to the mobile terminal in response to a user registration and is launched at the same time as said user registration.

8. A method in accordance with claim 7 wherein:
the wireless communication network is a 3G network providing a plurality of different multimedia services.

9. A mobile terminal in a wireless communication network adapted to support an interactive service relating to a video program, said mobile terminal comprising:
a system software, including an operating system and a Java profile; and
at least one Java midlet, wherein said Java midlet:
when launched, receiving information from a server relating to said video program;
upon the receipt of said information from the relating to said video program, invoking a user interface defined by said Java midlet;
prompting the user to provide an input to the interactive service, said prompt utilizing previous information concerning the user so that said prompt is provided automatically upon receipt of said information relating to said video program and without the need for prior action by the user; and
receiving the prompted user input and sending information indicating said prompted user input to said server.

10. A mobile terminal in accordance with claim 9, wherein said Java midlet supports a voting service and said Java midlet prompts the user to provide a vote.

11. A mobile terminal in accordance with claim 10, wherein said Java midlet enables the user to provide a vote by taking only one input action.

12. A mobile terminal in accordance with claim 10, wherein said mobile terminal comprises at least a second Java midlet in addition to said Java midlet supporting a video service.

13. A mobile terminal in accordance with claim 11, wherein said second Java midlet supports a second interactive service relating to a video program.

14. A mobile terminal in accordance with claim 13, wherein said second interactive service comprises a chat room.

15. A mobile terminal in accordance with claim 9, wherein said mobile terminal comprises a mobile phone.

16. A server in a communications network, said server carrying out an interactive service method related to a video program comprising:
providing a client software application to a mobile terminal, said client software application containing a user interface for the mobile terminal and supporting said interactive service method;
sending video program information to said mobile terminal related to said interactive service method, said video program information adapted to be presented to the user of said mobile terminal by said client software application; and receiving user information from said client software application, said user information indicating a user response to said presented video program information.

17. A server as recited in claim 15, wherein said client software application is provided in response to a registration request by a user of said mobile terminal.

18. A server as recited in claim 16, wherein said server comprises a registration database.

19. A server as recited in claim 17, wherein said server comprises an account database.

20. A server as recited in claim 15, wherein said interactive service comprises a voting service relating to said video program and said server conducts a vote among a selected plurality of users to calculate voting results related to said video program based on the user response received from said plurality of users.

21. A server as recited in claim 16, wherein said server selectively sends said video program information to said selected plurality of users based on information contained in said registration database.

22. A server as recited in claim 20, wherein said server maintains and provides a plurality of multimedia communications services to said mobile terminal.

23. A server as recited in claim 21, wherein said interactive service comprises a push service.

24. A server as recited in claim 22, wherein said server contains a software application adapted to control the interactive service with said mobile terminal.

25. A server as recited in claim 23, wherein said server communicates with a mobile terminal located in a wireless communication network.

26. A method as recited in claim 1, wherein said software application is activated by sending activation information in a cell broadcast service.

27. A method as recited in claim 1, wherein said software application is activated by sending activation information using the radio data system of an analog radio broadcast.

28. A method as recited in claim 1, wherein said information indicating said prompted user input is packaged by the software application and sent to the server over a message service.

29. A method as recited in claim 28, wherein the sending of said information indicating said prompted user input is delayed slightly depending on the capacity of the server and the network.

30. A mobile terminal as recited in claim 9, wherein said information indicating said prompted user input is packaged by the software application and sent to the server over a message service.

31. A mobile terminal as recited in claim 30, wherein the sending of said information indicating said prompted user input is delayed slightly depending on the capacity of the server and the network.

32. A mobile terminal adapted to perform the method recited in claim 1.

33. A method in accordance with claim 2, wherein said prompt relates to an event in said video program and occurs substantially immediately after said event in said video program.

34. A method in accordance with claim 2, wherein said prompt includes tactile notification.

35. A method in accordance with claim 33, wherein said tactile notification comprises vibration of the mobile terminal.

36. A method in accordance with claim 2, wherein said prompt includes a distinctive ringing tone.

37. A method in accordance with claim 28, wherein the message service is SMS.

38. A method in accordance with claim 28, wherein the message service is MMS.

39. A method in accordance with claim 30, wherein the message service is SMS.

40. A method in accordance with claim 30, wherein the message service is MMS.

41. A mobile terminal for providing an interactive service relating to a video program to a user, comprising:
means for launching a software application stored in the mobile terminal, said software application, when launched, being prepared to receive information from a server relating to said video program;
means for activating said software application upon the receipt of said information from the server relating to said video program, said activation including invocation of a user interface defined by said software application;
means for prompting the user to provide an input to the interactive service, said prompt utilizing previous information concerning the user so that said prompt is provided automatically upon receipt of said information relating to said video program and without the need for prior action by the user; and
means for receiving the prompted user input and sending information indicating said prompted user input to said server.
